(19) United States
(12) Patent Application Publication
(10) Pub. No.: US 2005/0237151 A1
(43) Pub. Date: Oct. 27, 2005

(54) Function setting method to be implemented using an anti-theft device

(75) Inventor: Jeffrey Cheng, Chung-Ho City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: WINTECRONICS CO., LTD.

(21) Appl. No.: 10/822,769

(22) Filed: Apr. 13, 2004

(51) Int. Cl. H04B 1/00

(52) U.S. Cl. 340/5.62; 340/825.72; 340/426.15; 307/10.2

(57) ABSTRACT

A function setting method is implemented using an anti-theft device that includes a base module and a remote controller, and includes the steps of operating a remote controller to select one of function signals, enabling the remote controller to wirelessly transmit the currently selected one of the function signals for reception by the base module, and enabling the base module to change a previously selected function setting of a security function of the base module with a function setting that is associated with the currently selected one of the function signals.

### BACKGROUND OF THE INVENTION

1. Field of the Invention

The invention relates to a function setting method to be implemented using an anti-theft device, more particularly to a function setting method that permits changes in function settings by remote control.

2. Description of the Related Art

A conventional anti-theft device for an automobile includes a base module and a remote controller. The base module is operable so as to provide at least one security function that is capable of being set to different function settings. In order to change a previously selected one of the function settings of the security function of the base module of the conventional anti-theft device with a currently selected one of the function settings, one of the following conventional methods may be used:
1. adjusting function switches on the base module to the currently selected one of the function settings; and
2. using an external function-setting changer to transmit data corresponding to the currently selected one of the function settings to the base module so as to overwrite data corresponding to the previously selected one of the function settings through a wired communications link that interconnects output and input ports of the function-setting changer and the base module, respectively.

The aforementioned conventional methods are disadvantageous in that both require physical manipulation of the base module. This causes inconvenience on the part of the user since the base module of the conventional anti-theft device is normally concealed in the automobile. Furthermore, use of the function-setting changer in the second conventional method incurs extra costs.

### SUMMARY OF THE INVENTION

Therefore, the object of the present invention is to provide a function setting method to be implemented using an anti-theft device so as to overcome the aforesaid drawbacks of the prior art.

According to one aspect of the present invention, a function setting method is to be implemented using an anti-theft device that includes a remoter controller and a base module, and comprises the steps of:
(A) operating a remote controller to select one of function signals;
(B) enabling the remote controller to wirelessly transmit the currently selected one of the function signals for reception by the base module; and
(C) enabling the base module to change a previously selected function setting of a security function of the base module with a function setting that is associated with the currently selected one of the function signals.

According to another aspect of the present invention, an anti-theft device comprises a base module and a remote controller. The base module is operable so as to provide at least one security function that is capable of being set to different functions settings. The base module includes a memory unit, a receiver circuit, and a controller unit coupled to the receiver circuit and the memory unit. The memory unit serves to store a previously selected one of the function settings. The receiver circuit is operable so as to wirelessly receive a currently selected one of function signals. The controller unit is operable so as to control operation of the base module in accordance with the previously selected one of the function settings stored in the memory unit, and so as to overwrite the previously selected one of the function settings stored in the memory unit with a function setting associated with the currently selected one of the control signals received by the receiver circuit. The remote controller is operable so as to transmit the currently selected one of the function signals. The remote controller includes a processor unit, a function key set, and a transmitter circuit. The function key set is coupled to the processor unit, and is operable so as to control selection of the function signals by the processor unit. The transmitter circuit is coupled to the processor unit, and is operable so as to wirelessly transmit the currently selected one of the function signals for reception by the base module.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of a base module of the preferred embodiment of an anti-theft device according to the present invention;

FIG. 2 is a schematic circuit block diagram of a remote controller of the preferred embodiment; and

FIG. 3 is a flowchart to illustrate consecutive steps of the preferred embodiment of a function setting method according to the present invention.

### DETAILED DESCRIPTION OF THE PREFERRED EMBODIMENT

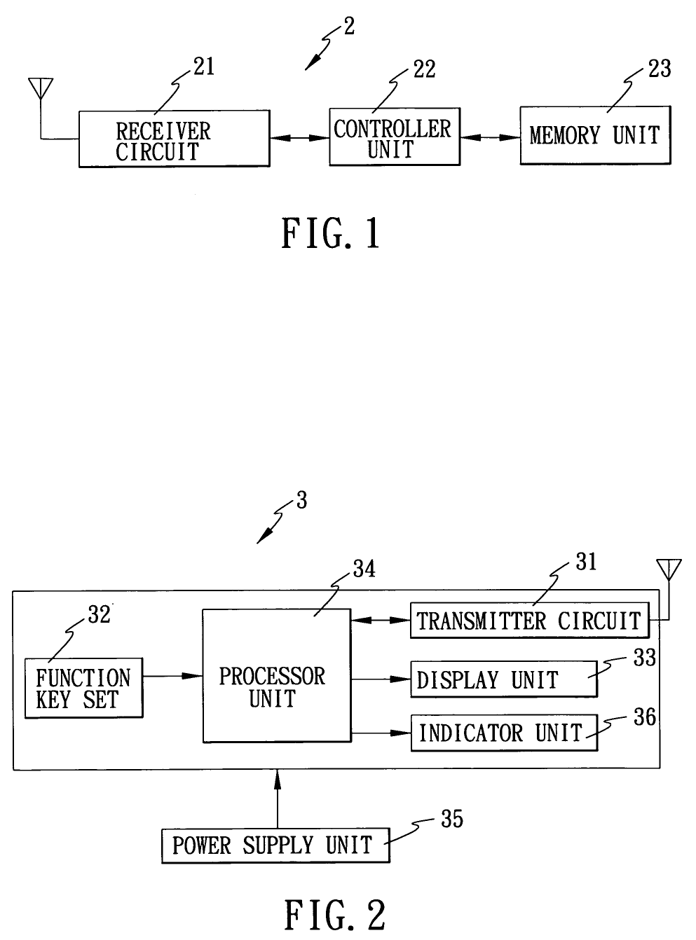

Referring to FIGS. 1 and 2, the preferred embodiment of an anti-theft device according to the present invention is shown to include a base module 2 and a remote controller 3.

The base module 2 is adapted to be disposed in an automobile (not shown), and is operable so as to provide at least one security function that is capable of being set to different function settings, in a manner that will be described hereinafter.

The base module 2 includes a memory unit 23, a receiver circuit 21, and a controller unit 22 coupled to the memory unit 23 and the receiver circuit 21. The memory unit 23 serves to store a previously selected one of the function settings. The controller unit 22 is operable so as to control operation of the base module 2 in accordance with the previously selected one of the function settings stored in the memory unit 23. The receiver circuit 21, which is a known transceiver in this embodiment, is operable so as to wirelessly receive a currently selected one of function signals. The controller circuit 22 is further operable so as to overwrite the previously selected one of the function settings stored in the memory unit 23 with a function setting associated with the currently selected one of the function signals received by the receiver circuit 21.

In this embodiment, the remote controller 3 is operable in a normal operation mode, where the remote controller 3 transmits control signals that are to be received by the base module 2 for controlling operation of the base module 2, in a manner well known in the art, and in a function-setting mode, where the remote controller 3 transmits the currently selected one of the function signals for changing the previously selected one of the function settings of the security function of the base module 2 with a function setting that is associated with the currently selected one of the function signals.

The remote controller 3 includes a processor unit 34, and a function key set 32 and a transmitter circuit 31 that are coupled to the processor unit 34. The function key set 32 is operable so as to control selection of function signals by the processor unit 34. The transmitter circuit 31, which is a known transceiver in this embodiment, is operable so as to transmit the currently selected one of the function signals wirelessly for reception by the base module 2.

The remote controller 3 further includes a display unit 33 coupled to the processor unit 34. The display unit 33 provides menu-driven display patterns (not shown). The menu-driven display patterns include at least one menu that indicates the security function of the base module 2, and submenus, each of which corresponds to a respective one of the function signals and indicates a function setting associated with the respective one of the function signals. In this embodiment, the display unit 33 includes a liquid crystal display.

In operation, when it is desired to change a previously selected one of the function settings of the security function, such as activation time of the door lock of the automobile, of the base module 2, the remote controller 3 is first operated in the function-setting mode. While in the function-setting mode, the function key set 32 can be operated so as to enable the processor unit 34 to select one of the function signals, such as one second after starting the engine of the automobile. That is, the menu that corresponds to the security function is highlighted and selected, and then the submenu that corresponds to the function signal is highlighted and selected. Thereafter, the processor unit 34 is enabled to activate the transmitter circuit 31 so as to transmit the currently selected one of the function signals wirelessly for reception by the base module 2.

The base module 2 is further operable so as to transmit a response signal, such as for acknowledging receipt of the currently selected one of the function signals. The remote controller 3 further includes an indicator unit 36 coupled to the processor unit 34. The processor unit 34 activates the indicator unit 36 to provide an indication upon reception of the response signal. In this embodiment, the indicator unit 36 includes a beeper that generates an audible output, the number of beeps or the tone of which is varied for different response signals. In another embodiment, the indicator unit 36 includes at least one light emitting diode that generates visible light, the number of flashes or the color of which is varied for the different response signals. It is noted that that the indicator unit 36 may include both the beeper and at least one of light emitting diode.

It is noted that the processor unit 34 may be configured to activate the indicator unit 36 to provide the indication signal when the remote controller 3 exits the function-setting mode.

The remote controller 3 further includes a power supply unit 35 that supplies electric power to the processor unit 34, the transmitter circuit 31, the function key set 32, the display unit 33, and the indicator unit 36.

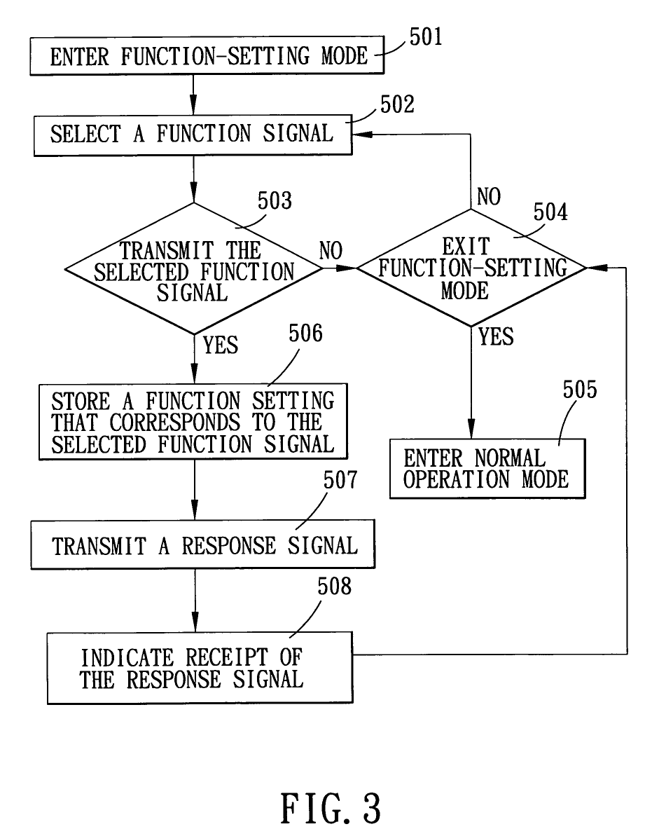

The preferred embodiment of a function setting method to be implemented using the anti-theft device according to this invention includes the steps shown in FIG. 3.

In step 501, the remote controller 3 is operated to enter the function-setting mode. In step 502, the function key set 32 is operated to control selection of the function signals by the processor unit 34. After the selection, in step 503, the processor unit 34 controls the display unit 33 to provide a first inquiry to verify transmission of the currently selected one of the function signals. If the remote controller 3 receives an affirmative response to the first inquiry, the flow goes to step 506. If, however, the remote controller 3 receives a negative response to the first inquiry, in step 504, the processor unit 34 controls the display unit 33 to provide a second inquiry to verify exit from the function-setting mode. If the remote controller 3 receives an affirmative response to the second inquiry, in step 505, the remote controller 3 exits the function-setting mode and enters the normal operation mode. If, on the other hand, the remote controller 3 receives a negative response to the second inquiry, the flow returns to step 502. In step 506, the base module 2 overwrites the previously selected one of the function settings stored in the memory unit 23 with a function setting associated with the currently selected one of the functions signals. In step 507, the base module 2 transmits a response signal for acknowledging receipt of the currently selected one of the function signals. In step 508, the indicator unit 36 of the remote controller 3 provides the indication signal upon receipt of the response signal by the remote controller 3. Thereafter, the flow goes to step 504.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A function setting method to be implemented using an anti-theft device that includes a remoter controller and a base module, comprising the steps of:
(A) operating the remote controller to select one of function signals;
(B) enabling the remote controller to wirelessly transmit the currently selected one of the function signals for reception by the base module; and
(C) enabling the base module to change a previously selected function setting of a security function of the base module with a function setting that is associated with the currently selected one of the function signals.

2. The function setting method as claimed in claim 1, further comprising the step of enabling operation of the remote controller in a function-setting mode prior to step (A).

3. The function setting method as claimed in claim 1, further comprising the step of enabling the base module to wirelessly transmit a response signal to be received by the remote controller after step (C).

4. The function setting method as claimed in claim 1, wherein step (B) is performed only when the remote controller receives an affirmative response to an inquiry to perform step (B).

5. The function setting method as claimed in claim 1, wherein step (A) is performed only when the remote controller receives an affirmative response to a first inquiry to perform step (A).

6. The function setting method as claimed in claim 5, wherein step (B) is performed only when the remote controller receives an affirmative response to a second inquiry to perform step (B).

7. The function setting method as claimed in claim 6, wherein step (A) is repeated when the remote controller receives a negative response to the second inquiry to perform step (B).

8. The function setting method as claimed in claim 2, wherein operation of the remote controller in the function-setting mode is enabled only upon receipt by the remote controller of an affirmative response to an inquiry made thereby.

9. The function setting method as claimed in claim 3, further comprising the step of enabling the remote controller to provide an indication signal upon receipt of the response signal.

10. An anti-theft device, comprising:
a base module operable so as to provide at least one security function that is capable of being set to different function settings, said base module including
a memory unit for storing a previously selected one of the function settings,
a receiver circuit operable so as to wirelessly receive a currently selected one of function signals, and
a controller unit coupled to said receiver circuit and said memory unit,
said controller unit being operable so as to control operation of said base module in accordance with the previously selected one of the function settings stored in said memory unit,
said controller unit being further operable so as to overwrite the previously selected one of the function settings stored in said memory unit with a function setting associated with the currently selected one of the control signals received by said receiver circuit; and
a remote controller operable so as to transmit the currently selected one of the function signals, said remote controller including
a processor unit,
a function key set coupled to said processor unit, and operable so as to control selection of the function signals by said processor unit, and
a transmitter circuit coupled to said processor unit and operable so as to wirelessly transmit the currently selected one of the function signals for reception by said base module.

11. The anti-theft device as claimed in claim 10, wherein said remote controller further includes a display unit coupled to said processor unit, said display unit providing a plurality of display patterns, each of which corresponds to a respective one of the function signals, and indicates a function setting associated with the respective one of the function signals.

12. The anti-theft device as claimed in claim 11, wherein said base module is further operable so as to transmit response signals that are to be received by said remote controller.

13. The anti-theft device as claimed in claim 12, wherein said remote controller further includes an indicator unit coupled to said processor unit, said indicator unit being controlled by said processor unit to provide an indication signal upon receipt of the response signal from said base module.

14. The anti-theft device as claimed in claim 13, wherein said indicator unit includes at least one of a light emitting diode and a buzzer.
